(19) United States
(12) Patent Application Publication
(10) Pub. No.: US 2009/0163079 A1
(43) Pub. Date: Jun. 25, 2009

(54) DATA STORAGE DEVICE AND METHOD

(76) Inventor: Quang V.T. Nguyen, Toronto (CA)

Correspondence Address: BERESKIN AND PARR, 40 KING STREET WEST, BOX 401, TORONTO, ON, M5H 3Y2, CA

(21) Appl. No.: 12/067,884

(22) PCT Filed: Sep. 25, 2006
(86) PCT No.: PCT/CA2006/001576

§ 371 Date: Mar. 24, 2008

Related U.S. Application Data
(60) Provisional application No. 60/719,578, filed on Sep. 23, 2005.

(51) Int. Cl. H01R 9/03; G06F 13/00; H02G 15/06; G11B 5/82

(52) U.S. Cl. 439/607.41; 710/300; 174/75 C; 360/135; G9B/5.293

(57) ABSTRACT

In various embodiments, applicant's teachings are related to an apparatus and method of providing a data storage device to be interfaced between a data receiving apparatus in a data collecting configuration and a data processor in a data retrieval configuration. In various embodiments, applicant's teachings are related to an apparatus and method of selectively operating a data storage device to receive data from a data receiving apparatus. In some embodiments, the data storage device receives data when an acceptable operating condition of the device is sensed. In various embodiments, applicant's teachings are related to an apparatus and method to reduce the time that the data storage device is in operation while it is collecting the data.

This application claims the benefit of U.S. Provisional Application No. 60/719,578, filed Sep. 23, 2005, the entire contents of which is hereby incorporated by reference.

The section headings used herein are for organizational purposes only and are not to be construed as limiting the subject matter described in any way.

### FIELD

Applicant's teachings are related to a data storage device and method.

### INTRODUCTION

The need to record information is ever expanding. In particular, as technology advances there are a greater number of devices that provide information, which people may wish to store. This information can encompass a wide variety of signals from sources such as, for example, but not limited to, cameras, microphones and other sensors that detect conditions to be monitored. In addition, the advancement of technology has provided for smaller and more portable devices, which allows for transporting these devices to environments that may have extreme conditions such as extreme temperatures and turbulence.

The information that is stored on these devices is often stored on devices that may not be well suited to the extreme conditions in which they are used. For example, some storage media such as hard disk drives have moving parts and are not amenable for use in environments with a lot of turbulence or where shock waves may be produced. Furthermore, these storage devices may also only operate within certain temperature ranges. When these data storage devices are taken to environments where the temperature falls outside a specified operating range it may not be possible to record information on the drive, possibly resulting in valuable information being lost.

### SUMMARY

In various embodiments, applicant's teachings are related to an apparatus and method of providing a data storage device to be interfaced between a data receiving apparatus in a data collecting configuration and a data processor in a data retrieval configuration. In various embodiments, applicant's teachings are related to an apparatus and method of selectively operating a data storage device to receive data from a data receiving apparatus. In some embodiments, the data storage device receives data when an acceptable operating condition of the device is sensed. In various embodiments, applicant's teachings are related to an apparatus and method to reduce the time that the data storage device is in operation while it is collecting the data.

In some embodiments of applicant's teachings a removable data storage device is provided where the device comprises a first connector to removably connect the data storage device to a data receiving apparatus so that data received can be written to the data storage device, and a second connector to removably connect the data storage device to a data processor, the data processor separate from the data receiving apparatus.

In some embodiments, the first connector can be, for example, but not limited to, a multiple point contact connector. In some embodiments, the first connector can be, for example, but not limited to, a multiple-pin connector.

In some embodiments, the second connector can be, for example, but not limited to, a universal serial bus connector, a serial advanced technology attachment connector, and an IEEE 1394 high-speed serial bus connector.

In various embodiments of applicant's teachings, the data storage device further comprises a memory device, which in some embodiments of applicant's teachings can be, for example, but not limited to, a hard disk drive.

In various embodiments of applicant's teachings, the data storage device further comprises a printed circuit board upon which the memory device and first and second connectors are mounted. The memory device can communicate with the first and second connectors via the printed circuit board.

Moreover, various embodiments of applicant's teachings provide for a method of providing a data storage device to be interfaced between a data receiving apparatus in a data collecting configuration and a data processor in a data retrieval configuration. The method comprises, in a data collecting configuration, connecting the data storage device to a data receiving apparatus by a first connector so that data received can be written to the data storage device, and, in a data retrieval configuration, disconnecting the data storage device from the data receiving apparatus, and connecting the data storage device to a data processor by a second data connector so that data from the data storage device can be received by the data processor.

In some embodiments of the method of applicant's teachings the first connector can be, for example, but not limited to, a multiple point contact connector. In some embodiments, the first connector can be, for example, but not limited to, a multiple-pin connector.

In some embodiments of the method of applicant's teachings, the second connector can be, for example, but not limited to, a universal serial bus connector, a serial advanced technology attachment connector, and an IEEE 1394 high-speed serial bus connector.

Moreover, in various embodiments of applicant's teachings, the data storage device further comprises a memory device, which in some embodiments of applicant's teachings can be, for example, but not limited to, a hard disk drive.

In various embodiments of applicant's teachings, the data storage device further comprises a printed circuit board, upon which the memory device and first and second connectors are mounted. The memory device can communicate with the first and second connectors via the printed circuit board.

Applicant's teachings also provide, in various embodiments, for a data storage device, where the device comprises a first connector to connect the data storage device to a data receiving apparatus, at least one sensor to sense at least one condition relevant to an acceptable operating condition of the data storage device, and a first switch linked to the at least one sensor, the first switch to disconnect a source of power to the data storage device when the sensor senses a condition outside the acceptable operating condition of the data storage device.

In some embodiments of applicant's teachings the source of power to the data storage device is provided through the first connector.

Moreover, in some embodiments of applicant's teachings, the sensor can be, for example, but not limited to, a temperature sensor, a vibration sensor, an impact sensor, a humidity sensor, and an accelerometer.

In various embodiments of applicant's teachings at least two sensors are provided, each sensor is linked to the first switch to independently disconnect the source of power to the data storage device. In some embodiments of applicant's teachings each of the at least two sensors can sense a different condition relevant to an acceptable operating condition of the data storage device.

Moreover, in various embodiments of applicant's teachings, the device further comprises a second connector to connect the data storage device to a data processor, and, in some embodiments, the data processor is separate from the data receiving apparatus. In some embodiments, for example, but not limited to, the data processor can be a personal computer.

In some embodiments of applicant's teachings, the second connector provides the source of power to the data storage device when the data storage device is connected to the data processor.

In various embodiments of applicant's teachings the first switch disconnects the source of power provided by the second connector when the sensor senses a condition outside the acceptable operating condition of the data storage device.

In some embodiments of applicant's teachings the second connector is, for example, but not limited to, a universal serial bus connector, a serial advanced technology attachment connector, and an IEEE 1394 high-speed serial bus connector.

In various embodiments of applicant's teachings, the first connector is, for example, but not limited to, a multiple point contact connector. In some embodiments, the first connector is, for example, but not limited to, a multiple-pin connector.

Moreover, in various embodiments of applicant's teachings, the data storage device further comprises a memory device, which in some embodiments of applicant's teachings can be, for example, but not limited to, a hard disk drive.

In various embodiments of applicant's teachings, the data storage device further comprises a printed circuit board upon which the memory device and first and second connectors are mounted. The memory device can communicate with the first and second connectors via the printed circuit board.

Further, in accordance with various embodiments of applicant's teachings, the data storage device comprises a heating element thermally linked to the data storage device. In some embodiments, the heating element is independently connected to the source of power so that the first switch cannot disconnect the source of power to the heating element. In some embodiments, the heating element is connected to the source of power through the first connector.

In some embodiments of applicant's teachings, the heating element is at least one trace provided on the printed circuit board.

In some embodiments of applicant's teachings a second temperature sensor to sense the temperature of the data storage device is provided, and a second switch linked to the second temperature sensor. The second switch is to connect or disconnect the source of power to the heating element when the second temperature sensor detects a temperature outside a select range. For example, when the second temperature sensor detects a temperature below a select temperature, the second switch connects the source of power to the heating element. When the second temperature sensor detects a temperature above a select temperature, the second switch disconnects the source of power from the heating element.

In some embodiments of applicant's teachings, a third temperature sensor to sense the temperature of the data storage device is provided, and a third switch linked to the third temperature sensor. The third switch to disconnect the source of power to the heating element when the third temperature sensor detects a temperature higher than a select temperature.

Moreover, in some embodiments of applicant's teachings at least one of the second and third sensors are linked to the data receiving apparatus through the first connector.

Moreover, in various embodiments of applicant's teachings, a control logic linked to the at least one sensor and to the first switch can be provided. The control logic to control the first switch in response to the condition sensed by the sensor. In some embodiments, the control logic can link the at least one sensor and the second temperature sensor to the first switch and second switch, respectively. The control logic controls the first switch and the second switch in response to the conditions sensed by the at least one sensor and the second sensor.

In various embodiments of applicant's teachings, the control logic is a micro controller.

Moreover, in various embodiments of applicant's teachings, the control logic is provided on the printed circuit board.

Further, various embodiments of applicant's teachings provide for a method of selectively operating a data storage device to receive data from a data receiving apparatus. In various embodiments, the method comprises connecting the data storage device to a data receiving apparatus, sensing at least one condition relevant to an acceptable operating condition of the data storage device, and upon sensing a condition outside the acceptable operating condition of the data storage device, disconnecting a source of power to the data storage device.

In various embodiments of the method of the invention the at least one condition is sensed by at least one sensor.

Moreover, in various embodiments of applicant's teachings, the power source to the data storage device can be disconnected by a first switch.

Further, in various embodiments of applicant's teachings the data storage device is connected to the data receiving apparatus by a first connector. The source of power to the data storage device can be provided through the first connector.

Moreover, in various embodiments of the method of applicant's teachings, the sensor is a temperature sensor. The sensor can be, for example, but not limited to, a vibration sensor, an impact sensor, a humidity sensor, and an accelerometer.

In addition, some embodiments of the method of applicant's teachings, at least two sensors are provided, and each sensor is linked to the first switch to independently disconnect the source of power to the data storage device. In some embodiments of applicant's teachings each of the at least two sensors can sense a different condition relevant to an acceptable operating condition of the data storage device.

Applicant's teachings also provide for a method to selectively operate a data storage device connected to a data processor by connecting the data storage device to the data processor, the data processor separate from the data receiving apparatus, sensing at least one condition relevant to an acceptable operating condition of the data storage device, and upon sensing a condition outside the acceptable operating condition of the data storage device, disconnecting a source of power to the data storage device.

In some embodiments of applicant's teachings, the data storage device is connected to the data receiving apparatus by a second connector. The second connector can, in some embodiments, provide the source of power to the data storage device when the data storage device is connected to the data processor.

In various embodiments of applicant's teachings the first switch can disconnect the source of power provided by the second connector, when the sensor senses a condition outside the acceptable operating condition of the data storage device.

In some embodiments of applicant's teachings the second connector can be, for example, but not limited to, a universal serial bus connector, a serial advanced technology attachment connector, and an IEEE 1394 high-speed serial bus connector.

Moreover, the first connector in the method of applicant's teachings can be, for example, but not limited to, a multiple point contact connector. In some embodiments the first connector is, for example, but not limited to, a multiple-pin connector.

In various embodiments, the data storage device further comprises a memory device, which in some embodiments of applicant's teachings can be, for example, but not limited to, a hard disk drive.

In various embodiments of applicant's teachings, the data storage device includes a printed circuit board upon which the memory device and first and second connectors are mounted. The memory device can communicate with the first and second connectors via the printed circuit board.

Further, in the method of various embodiments of applicant's teachings a heating element thermally linked to the data storage device is provided. The heating element can be connected to the source of power. In some embodiments, the heating element is independently connected to the source of power so that the first switch cannot disconnect the source of power to the heating element. In some embodiments of the method of applicant's teachings, the heating element is connected to the source of power through the first connector.

Moreover, in some embodiments of applicant's teachings, the heating element is at least one trace provided on the printed circuit board.

In various embodiments of the method of applicant's teachings a second temperature sensor to sense the temperature of the data storage device, and a second switch linked to the second temperature sensor are provided. The second switch is to connect or disconnect the source of power to the heating element when the second temperature sensor detects a temperature outside a select range. For example, when the second temperature sensor detects a temperature below a select temperature, the second switch connects the source of power to the heating element. When the second temperature sensor detects a temperature above a select temperature, the second switch disconnects the source of power from the heating element.

In various embodiments of the method of applicant's teachings, a third temperature sensor to sense the temperature of the data storage device, and a third switch linked to the third temperature sensor are provided. The third switch is to disconnect the source of power to the heating element when the third temperature sensor detects a temperature higher than a select temperature.

Moreover, in some embodiments of applicant's teachings at least one of the second and third sensors are linked to the data receiving apparatus through the first connector.

Moreover, in various embodiments of the method of applicant's teachings a control logic linked to the at least one sensor and to the first switch is provided. The control logic to control the first switch in response to the condition sensed by the sensor. In some embodiments, the control logic links the at least one sensor and second temperature sensor to the first switch and second switch, respectively. The control logic to control the first switch and second switch in response to the conditions sensed by the at least one sensor and the second sensor.

In various embodiments of applicant's teachings the control logic is a micro controller. Moreover, in various embodiments of applicant's teachings, the control logic is provided on the printed circuit board.

In various embodiments of applicant's teachings a data collector is provided. The data collector comprises a data receiving apparatus, at least one initial data storage device to receive data from the data receiving apparatus, the at least one initial data storage device operable for a first total time over a data collecting period, and at least one main data storage device to receive the data from the at least one initial data storage device, the at least one main data storage device operable for a second total time over the data collecting period, the second total time less than the first total time.

In various embodiments of applicant's teachings, the at least one initial data storage device has a first power requirement and the at least one main data storage device has a second power requirement, and the first power requirement is less than the second power requirement. Accordingly, in various embodiments of applicant's teachings the at least one initial data storage device, which requires less power than the at least one main data storage device is operated for a greater total time than the at least one main data storage device.

Moreover, in various embodiments of applicant's teachings, the at least one initial data storage device has a range of acceptable operating conditions that is greater than the range of acceptable operating conditions for the at least one main data storage device. Accordingly, in various embodiments of applicant's teachings the at least one initial data storage device which has a greater range of operating conditions, is operated for a greater total time than the at least on main data storage device.

In various embodiments of applicant's teachings the at least one initial data storage device can operate to receive the data from the data receiving apparatus at any time over the data collecting period. In some embodiments of applicant's teachings, the at least one initial data storage device can comprise, for example, a solid-state drive.

In various embodiments of applicant's teachings the at least one main data storage device is selectively operated so as to receive the data from the initial data storage device in select intervals over the data collecting period. In some embodiments of applicant's teachings, the at least one main data storage device can comprise, for example, a hard disk drive.

Further, in various embodiments of applicant's teachings, control logic is provided to selectively operate the at least one main data storage device to receive the data in select intervals over the data collecting period is provided.

In some embodiments, the at least one initial data storage device and the at least one main data storage device are connected to the data receiving apparatus. The data receiving apparatus can provide the control logic in some embodiments.

Moreover, in various embodiments, the control logic operates the at least one main data storage device when the at least one initial data storage device has reached a pre-selected capacity.

Further, in various embodiments of the applicant's teachings, at least one sensor is provided to sense at least one condition relevant to an acceptable operating condition of the at least one main data storage device.

In some embodiments the control logic disconnects a source of power to the at least one main data storage device when the sensor senses a condition outside the acceptable operating condition of the main storage device.

The sensor can be, for example, but not limited to, a temperature sensor, a vibration sensor, an impact sensor, a humidity sensor, and an accelerometer.

Moreover, in some embodiments of the method of applicant's teachings, at least two sensors are provided, and each sensor is linked to the first switch to independently disconnect the source of power to the data storage device. In some embodiments of applicant's teachings each of the at least two sensors can sense a different condition relevant to an acceptable operating condition of the data storage device.

In some embodiments of applicant's teachings the at least one main data storage device is connected to the data receiving apparatus by, for example, but not limited to, a multiple point contact connector. The connector can be, for example, but not limited to, a multiple-pin connector.

Further, the data receiving apparatus can receive data from, for example, but not limited to, a camera, a microphone and/or a data sensor.

Various embodiments of applicant's teachings provide for a method to reduce the time that a main data storage device is in operation while it is collecting data. The method comprises transferring data from a data receiving apparatus to at least one initial data storage device, the at least one initial data storage device operable for a first total time over a data collecting period, and transferring the data from the at least one initial data storage device to at least one main data storage device, the at least one main data storage device operable for a second total time over the data collecting period, the second total time less than the first total time.

In the method according to various embodiments of applicant's teachings the data can be transferred from the at least one initial data storage device to the at least one main data storage device when the at least one initial data storage device has reached a pre-selected capacity.

Moreover, in various embodiments of applicant's teachings, the at least one initial data storage device has a greater range of operating conditions than the at least one main data storage device. Accordingly, in various embodiments of applicant's teachings the at least one initial data storage device which has a greater range of operating conditions, is operated for a greater total time than the at least on main data storage device.

In various embodiments of applicant's teachings the at least one initial data storage device can operate to receive the data from the data receiving apparatus at any time over the data collecting period. In some embodiments of applicant's teachings, the at least one initial data storage device can comprise, for example, a solid-state drive.

In various embodiments of applicant's teachings the at least one main data storage device is selectively operated so as to receive the data from the initial data storage device in select intervals over the data collecting period. Further, in some embodiments of applicant's teachings, the at least one main data storage device can comprise, for example, a hard disk drive.

Moreover, in various embodiments, after data has been transferred from the initial data storage device to the main data storage device, the initial data storage device can receive further data from the data receiving apparatus. In some embodiments of applicant's teachings this is accomplished by designating the data, which is still stored on the initial data storage device but has already been transferred to the main storage device, as transferred data. The initial data storage device can then treat the transferred data as data that may be overwritten with new data.

In addition, various embodiments of the method of applicant's teachings comprise sensing at least one condition relevant to an acceptable operating condition of the at least one main data storage device. Moreover, some embodiments, disconnect the at least one main data storage device from a source of power when a condition outside the acceptable operating condition of the main storage device is sensed. In some embodiments, at least one sensor senses the condition. The sensor can be, for example, but not limited to, a temperature sensor, a vibration sensor, an impact sensor, a humidity sensor, and an accelerometer.

In some embodiments of the method of applicant's teachings at least two sensors are provided, each sensor can independently detect a condition that can disconnect the source of power to the at least one main data storage device. In some embodiments of applicant's teachings each of the at least two sensors can sense a different condition relevant to an acceptable operating condition of the data storage device.

Moreover, in various embodiments, the at least one main data storage device is removable and connected to the data receiving apparatus by a multiple point contact connector. In some embodiments, the connector can be, for example, but not limited to, a multiple-pin connector.

Further, in accordance with some embodiments of applicant's teachings the data receiving apparatus receives data from, for example, but not limited to, a camera, a microphone and/or a data sensor.

Further, in accordance with various embodiments of applicant's teachings, a data collector is provided comprising a data receiving apparatus, at least one initial data storage device to receive data from the data receiving apparatus, the at least one initial data storage device having a first range of acceptable operating conditions, and at least one main data storage device to receive the data storage device, the at least one main data storage device having a second range of acceptable operating conditions, the second range of acceptable operating conditions less than the first range of operating conditions.

Further, in accordance with various embodiments of applicant's teachings a method of collecting data while a main data storage device is not in operation due to adverse operating conditions is provided, comprising transferring data from a data receiving apparatus to at least one initial data storage device while at least one main data storage device is not in operation due to adverse operating conditions, and transferring the data from the at least one initial data storage device to at least one main data storage device once the at least one main data storage device is within acceptable operating conditions.

Moreover, once the data is transferred to the at least one main data storage device the at least one initial data storage device is by-passed and the data can then be transferred from the data receiving apparatus to the at least one main data storage device.

These and other features of the applicant's teachings are set forth herein.

### DRAWINGS

The skilled person in the art will understand that the drawings, described below, are for illustration purposes only. The drawings are not intended to limit the scope of the applicant's teachings in any way.

FIG. 1A is a side view of the a removable data storage device according to some embodiments of applicant's teachings;

FIG. 1B is a top view of the removable data storage device of FIG. 1A;

FIG. 1C is a bottom view of the removable data storage device of FIG. 1A;

FIG. 1D illustrates a side view of a hard disk housing used as an outer protective layer for the data storage device of FIG. 1A;

FIG. 1E is a schematic diagram of a copper trace for use as a heating element on the printed circuit board of FIG. 1;

FIG. 1F is a schematic diagram of a multiple point contact connector;

FIGS. 2 to 7 are block diagrams of a removable data storage device according to various embodiments of applicant's teachings;

FIGS. 8 and 9 are block diagrams of a data collector according to various embodiments of applicant's teachings;

FIG. 10 is a flowchart illustrating single task programming for a data collector with no conditions sensors according to some embodiments of applicant's teachings;

FIG. 11 is a flowchart illustrating a multi task programming for a data collector with no condition sensors according to some embodiments of applicant's teachings; and

FIG. 12 is a flowchart illustrating single task programming for a data collector with at least one condition sensor according to some embodiments of applicant's teachings.

### DESCRIPTION OF VARIOUS EMBODIMENTS

In various embodiments, applicant's teachings are related to an apparatus and method of providing a data storage device to be interfaced between a data receiving apparatus in a data collecting configuration and a data processor in a data retrieval configuration. Further, in various embodiments, applicant's teachings are related to an apparatus and method of selectively operating a data storage device to receive data from a data receiving apparatus. In some embodiments, the data storage device receives data when an acceptable operating condition of the device is sensed. Moreover, in various embodiments, applicant's teachings are related to an apparatus and method to reduce the time that the data storage device is in operation while it is collecting the data.

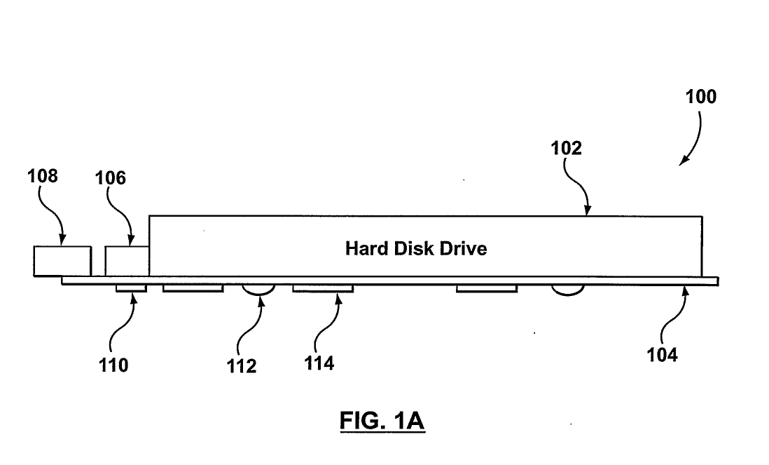

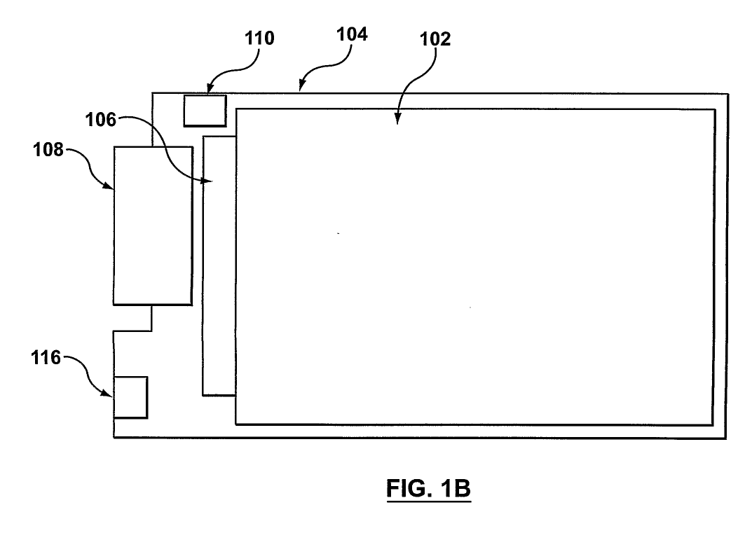

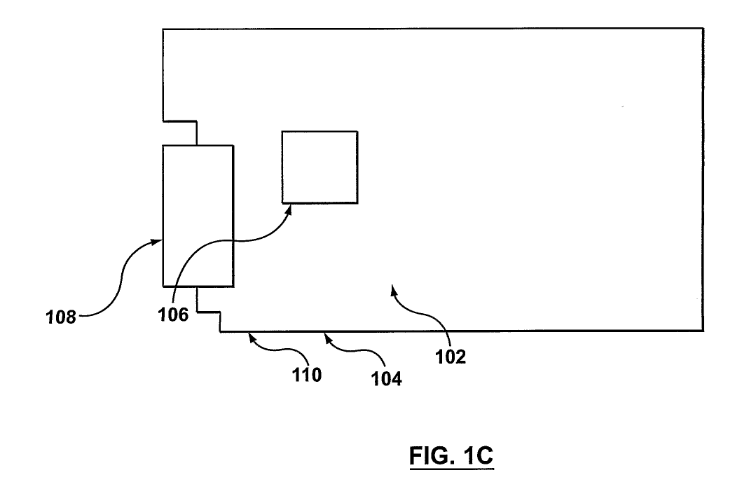

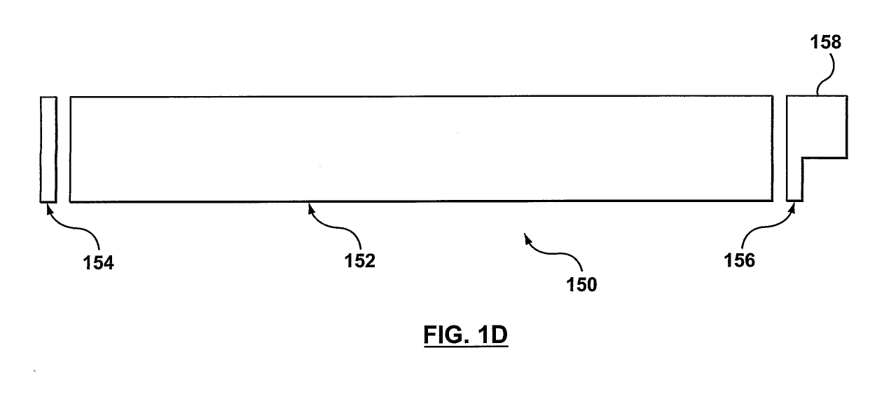

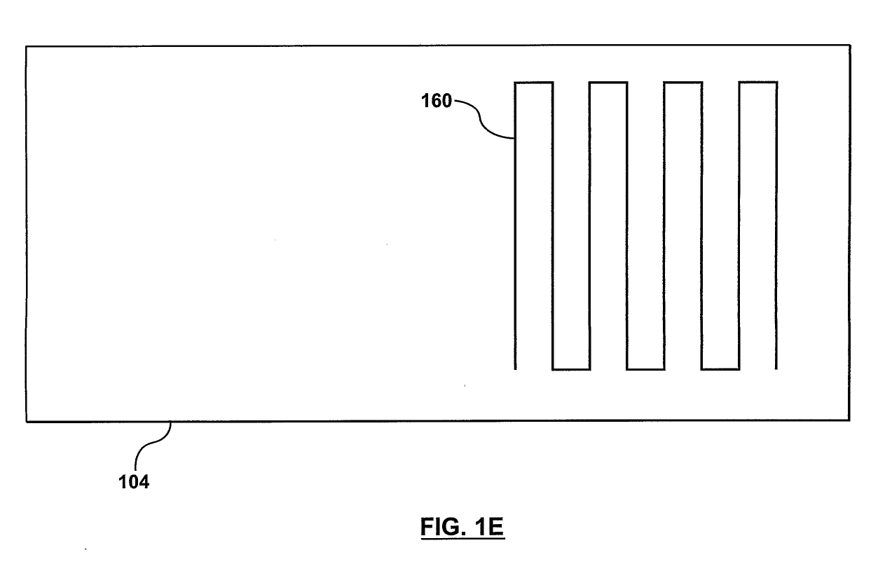

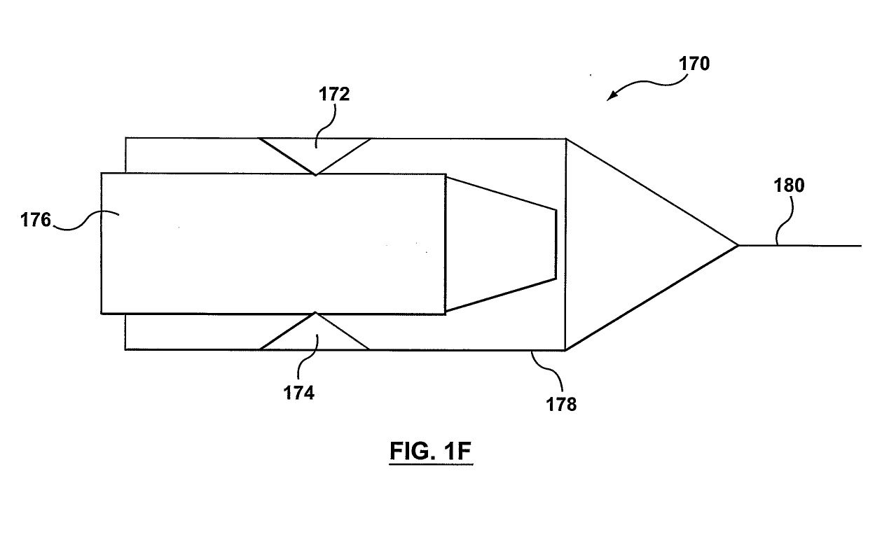

Referring now to FIG. 1A, a side view of a removable data storage device 100 according various embodiments of applicant's teachings is illustrated. FIGS. 1B and 1C illustrate top and bottom views, respectively, of removable data storage device 100 of FIG. 1A. For various embodiments of applicant's teachings, removable data storage device 100 comprises a memory device, which in some embodiments is a hard disk drive (HDD) 102, printed circuit board (PCB) 104, a first connector 108, PCB mounted HDD connector 106, one or more condition sensors 110, a plurality of HDD mounding screws 112 to mount the HDD directly to the PCB, a control integrated circuit (IC) 114, and a second connector 116. It should be understood that the disclosed embodiments are exemplary only and that other embodiments may vary. For example, but not limited to, the memory device HDD 102 may be replaced by a different type of memory device.

HDD 102 can be any number of HDD types having various protocols. For example, HDD 102 can have any of the PATA, SATA, or SCSI interfaces but is not limited to these protocols. PCB mounted HDD connector 106 is a connector for connecting the HDD 102 to PCB 104 and is chosen so as to correspond to the interface of HDD 102.

First connector 108 is provided for removably connecting data storage device 100 to a data receiving apparatus (not shown in FIGS. 1A-1D) so that data received or collected by the data receiving apparatus can be written to data storage device 100. Data receiving apparatus may receive data from any number of sources including, but not limited to, video, audio, radar and information signals, whether they are digital or audio. In the various embodiments, connector 108 is a rugged connector used in a data retrieval configuration. For various embodiments, the connector can have multiple pins, for example, but not limited to, 8 to 50 pins and can use 2 pins for every signal transmitted through the connector. It should be understood, however, that this is exemplary only and that other embodiments can have a different number of pins, for example 20 pins, and that for some embodiments of applicant's teachings 1 pin can be sufficient.

Furthermore, for some embodiments where 2 pins are used for every signal transmitted through the connector 108, a redundancy is implemented for, among other reasons, the purpose of reliability. In addition, the connector is designed to survive extreme operating conditions and survive a large number of insertions to and removals from the data receiving apparatus. Extreme operating conditions may include, but are not limited to, extreme temperatures, extreme vibrations, shocks, moisture levels, acceleration and turbulence.

As shown in FIG. 1F, and described hereinafter in more detail, connector 108 can be, for example, a multiple point contact connector. This can be achieved by having a single pin of connector 108 shaped and configured to contact the corresponding socket in the data receiving apparatus at multiple points along its length. In various embodiments of applicant's teachings each of the multiple pins is shaped and configured to provide multiple contacts when inserted in the corresponding socket of the data receiving apparatus.

Hard drive screws 112 are used to secure the HDD 102 to the PCB 104. Control IC 114 controls HDD 102 and converts signals between the protocol used by HDD 102 and first connector 108 and second connector 116.

For various embodiments of applicant's teachings, second connector 116 is a connector for removably connecting data storage device 100 to a data processor (not shown in FIGS. 1A-1D), and which is separate from the data storage device 100. The data processor can be, for example, but is not limited to, a standard computing device such as a personal computer or laptop. Connector 116 can be, for example, but not limited to, a Universal Serial Bus (USB) connector (for example a USB 2.0 connector), an IEEE 1394 high-speed serial bus connector or a Serial Advanced Technology Attachment (SATA) connector. However, it should be understood that these are only exemplarily and that other types of connector protocols can be used.

It can be appreciated that various embodiments of applicant's teaching can have the data storage device 100 communicating with the data processor through the first connector 108. Where first connector 108 is a multiple print contact connector and/or multiple connector, an adaptor can be provided, where needed, to allow the first connector to connect to the data processor.

In various embodiments, data storage device 100 can be configured, as will hereinafter be detailed, to transmit the same information, and using the same protocol over both connectors 108 and 116. For example, both could be configured to transmit the same information according to the USB 2.0 protocol. In addition the memory device, which in the exemplary embodiments illustrated in FIGS. 1A to 1C is HDD 102 can communicate with first connector 108 and second connector 116 via PCB 104. Moreover, in some embodiments, HDD 102 can communicate with first connector 108 and/or second connector 116 using a two-board connector.

Accordingly, in some embodiments of applicant's teachings the removable data storage device 100 operates in a data collecting configuration where the first connector 108, such as, for example, a multi-pin, multiple contact connector as previously disclosed, removably connects the data storage device 100 to a data receiving apparatus so that data received can be written to the data storage device 100.

Moreover, in a data retrieval configuration, the second connector 116, such as, for example, a Universal Serial Bus (USB) 2.0 connector, an IEEE 1394 high-speed serial bus connector, or a Serial Advanced Technology Attachment (SATA) connector, removably connects the data storage device 100 to a data processor. It can be appreciated that this allows the data storage device 100 to collect information in one location, be disconnected from the data receiving apparatus, and then subsequently connected to the data processor at a location separate from the data receiving apparatus, and possibly, for some embodiments, in a less hostile environment, or away from an area where a crash has occurred, for example, so that the data on the data storage device can be reviewed.

In various embodiments of applicant's teachings, temperature sensor 110 can be used to monitor the temperature of the data storage device 100, and, typically, HDD 102. The temperature sensor 110 can be placed in a location that allows the sensor to read a temperature that is reflective of the temperature of HDD 102. In some embodiments a location on the bottom of the PCB 104 and to one side of the PCB mounted HDD connector 106, is found to be sufficient. For various embodiments of applicant's teachings the temperature sensor location is generally sufficient when mounted away from the actual source of heat to be sensed (that is, the hard drive motor of HDD 102, and if included, a heating element—to be hereinafter described). However, it should be noted that the actual optimal location of the temperature sensor can vary according to parameters such as the type of hard drive used.

Moreover, in various embodiments of applicant's teachings, the sensor is not limited to a temperature sensor, but can be, for example, a vibration sensor, an impact sensor, a humidity sensor, an accelerometer, or any other sensor that can provide an indication of whether the environment that the data storage device 100 is currently located is, an environment where the HDD 102 should operate, as specified by, for example, a manufacturer of the HDD. For example, in a vehicle traveling off-road, a vibration sensor might detect moments of excessive vibration where the HDD 102 should not operate.

In various embodiments of applicant's teachings at least two sensors can be provided. In some embodiments of applicant's teachings each of the at least two sensors can sense a different condition relevant to the acceptable operating condition of the data storage device 100, and particularly HDD 102.

Further, data storage device 100 can be used in a variety of applications. For example, it can be used to store video and audio signals in a vehicle mounted digital and audio recorder. Alternatively it could used to store the data produced by any source of data signal regardless of whether it is digital or analog.

Reference is now made to FIG. 1D. FIG. 1D illustrates some embodiments of a hard disk housing 150 that can be used as an outer protective layer for data storage device 100. Hard disk housing 150 comprises, a main cover 152, a rear plate 154 and a front plate 156. For some embodiments a handle 158 is provided, such as, for example, handle 158 on front plate 156. The housing 150 main cover 152, rear plate 154, and front plate can be of rugged construction, for example, but not limited to, made of aluminum, to be able to withstand adverse environmental conditions.

Data storage device 100 further comprises, in various embodiments of applicant's teachings, a heating element. For some embodiments, the heating element is provided on or part of PCB 104. Reference is now made to FIG. 1E, which in a schematic diagram illustrates a copper trace 160 on PCB board 104 for use as a heating element. In some embodiments the heating element is at least one copper trace 160 on PCB 104. Copper trace 160 can be configured with select widths and lengths calculated to form a desired resistance so that heat is generated when a voltage is applied to the trace. In various embodiments the power generated by the heating element is 7 W to 25 W, though other embodiments utilize heating elements that generate other amounts of power. The heat should be sufficient to heat the HDD 102 of the data storage device when external environmental conditions act to reduce the temperature of the HDD 102 below a temperature that the HDD 102 should be operated, as specified by, for example, a manufacturer of the HDD. In accordance with some embodiments of applicant's teachings, other types of heating elements can be used.

In the embodiments as illustrated, the heating element and temperature sensor 110 are spaced from each other such that the heat generated by the heating element does not interfere with the temperature sensed by the temperature sensor 110. As can be seen from FIGS. 1A, 1B, and 1E, in some embodiments this is accomplished by utilizing a copper trace at one end of PCB 104 and a temperature sensor 110 at another end of the board.

Reference is now made to FIG. 1F, which in a schematic diagram illustrates a multiple point contact connector 170 for the first connector 108. In some embodiments, the first connector can be, for example, but not limited to, a multiple-pin connector. In some embodiments, the first connector can be, for example, but not limited to, both a multiple-pin connector and a multiple point contact connector where each pin and socket has multiple contacts as described.

Multiple point connector 170 utilizes multiple contact points 172 and 174 to provide electrical contact with pin 176. Contact points 172 and 174 are electrically connected to the inner wall 178 of connector 170, which is in turn linked to other circuitry through wire 180. Although some embodiments as illustrated utilize two contact points other embodiments utilize more contact points.

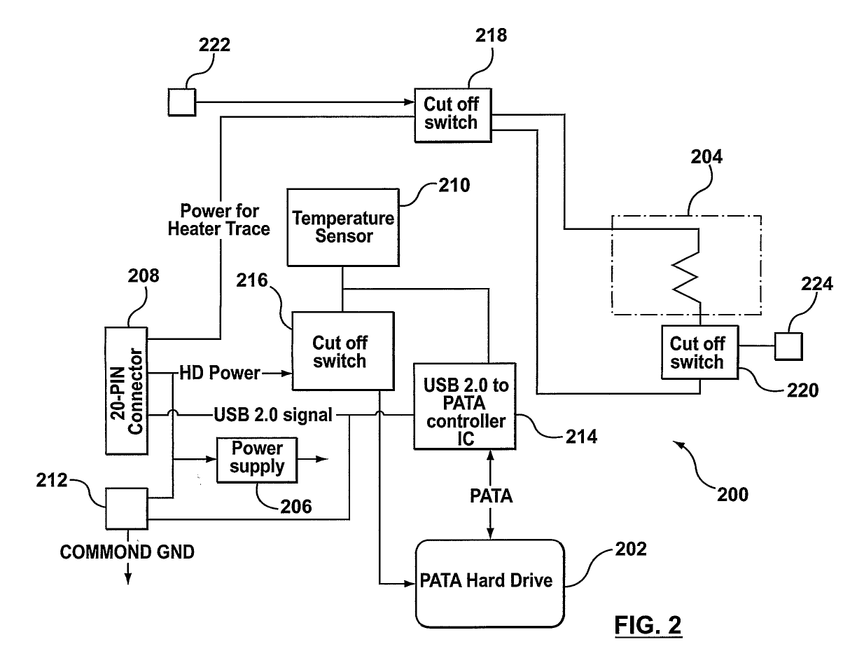

Reference is now made to FIG. 2, which in a block diagram illustrates a removable data storage device 200 according to various embodiments of applicant's teachings. The data storage device comprises a HDD 202, a heating element 204, a circuit power supply 206, a first connector 208, a first sensor 210 (which can be, as previously described, a temperature sensor), a second connector 212 with a common ground, a controller 214, a first cutoff switch 216, a second cutoff switch 218, a third cutoff switch 220, a second temperature sensor 222, and a third temperature sensor 224.

HDD 202 can be any appropriate disk drive operating according to any appropriate standard. For some embodiments as illustrated, HDD 202 is a Parallel Advanced Technology Attachment (PATA) hard drive. HDD 202 has a set of acceptable operating conditions. For example, it may operate effectively between 5° C. and 55° C. In addition, HDD 202 may not operate effectively above a given level of vibration or acceleration. Acceptable operating conditions for HDD 202 can be obtained, for example, from the manufacturer, or by subjecting a given HDD to extreme conditions and noting when the conditions cause failure of the device.

First connector 208, for various embodiments, is a rugged connector designed for repeatable insertions to and removal from a data receiving apparatus. A suitable first connector has been previously described herein. In the illustrated embodiments, connector 208 transmits a signal according to the USB 2.0 standard. Accordingly controller 214 converts signals between the USB 2.0 and PATA standards.

For the embodiments as illustrated, sensor 210 is a temperature sensor 210 to sense the temperature of HDD 202. Temperature sensor 210 is linked to first cutoff switch 216. When temperature sensor 210 senses a temperature outside the acceptable operating condition of HDD 202, cutoff switch 216 disconnects the power source from HDD 202.

Moreover, as previously mentioned, and as will be described hereinafter in greater detail with reference to further embodiments of applicant's teachings, the sensor 210 can be, for example, but not limited to, a temperature sensor, a vibration sensor, an impact sensor, a humidity sensor, and an accelerometer. In various embodiments of applicant's teachings at least two sensors can be provided, each sensor is linked to the first switch to independently disconnect the source of power to the data storage device. In some embodiments of applicant's teachings each of the at least two sensors can sense a different condition relevant to an acceptable operating condition of the data storage device.

In various embodiments of applicant's teachings, the source of power that the first switch 216 disconnects the data storage device 200 (and particularly HDD 202) from can be provided by the data receiving apparatus through first connector 208. This is typically the case when the data storage device 200 is operated in a data-collecting configuration. In some embodiments, the source of power can be provided from a separate connection and source, however, and for those embodiments, first switch 216 operates to disconnect HDD 202 from the separate power source.

In a data retrieval configuration, the data storage device 200 is connected to a data processor through second connector 212, as previously described. In this configuration for various embodiments of applicant's teachings, the source of power for the data storage device 200, and particularly HDD 202, is provided through the second connector 212, and it is that flow of power that the first switch 216 disconnects in this configuration. However, it should be understood that in some embodiments of applicant's teachings power to HDD 202 and other parts of the data storage device 200 may be provided by other means than through second connector 212.

Heating element 204 is used to heat HDD 202 when its temperature is outside the acceptable operating conditions, and particularly when the temperature of the HDD 202 falls below an acceptable operating temperature for the HDD. The second temperature sensor 222 is linked to the second cutoff switch 218. The second temperature sensor 222 and the second cutoff switch cooperate to selectively heat the HDD 202 using heating element 204. For example, when the second temperature 222 senses a temperature that indicates the HDD 202 is below a selected temperature suitable for operation of the HDD 202, cutoff switch 218 connects power to the heating element 204 to heat the HDD 202. In various embodiments of applicants teachings the above mentioned selected temperature is selected to be above the minimum acceptable operating temperature of HDD 202. In some embodiments the selected temperature is 5° C. to 10° C. above the minimum acceptable operating temperature of HDD 202. Selecting a temperature above a minimum operating temperature can ensure that the HDD temperature does not fall below its minimum acceptable temperature, which, in turn, should ensure that the HDD is available for operation when needed.

Further, when the temperature sensor 222 senses a temperature that indicates the HDD 202 is above a selected temperature suitable for operation of the HDD 202, cutoff switch 218 disconnects power from heating element 204.

In accordance with applicant's teachings, temperature sensor 222 can be mounted to the data storage device 200 in a location similar to sensor 110 (when a temperature sensor) as described above in relation to FIGS. 1A-1D. However, it can be appreciated that this is illustrative, and is not intended to be limiting for the position of the temperature sensor 222.

The third temperature sensor 224 is linked to a third cutoff switch 220. The third cutoff switch 220 and temperature sensor 224 act as fail-safe for cutoff switch 218 and the temperature sensor 222 in the event that power to heating element 204 is not disconnected when the temperature of HDD 202 is above an acceptable operating temperature. The third temperature sensor 224 senses the temperature of the data storage device. The third cutoff switch 220 disconnects the power to the heating element 204 when the temperature it senses is above a given temperature.

In accordance with applicant's teachings, temperature sensor 224 can be mounted to the data storage device 200 on the HDD 202. However, it can be appreciated that this is illustrative, and is not intended to be limiting for the position of the temperature sensor 224.

Moreover, for purposes of example, and not intended to be limiting, in a typical use, when temperature sensor 222 detects a temperature around 10° C. the cutoff switch 218 connects power to the heating element 204 to heat the HDD 202. When temperature sensor 222 detects a temperature around 30° C. the cutoff switch 218 disconnects power to the heating element 204 to heat the HDD 202. In the event that temperature sensor 222 and cutoff switch 218 fail to disconnect power to heating element 204, then temperature sensor 224 and cutoff switch 220 will disconnect power to the heating element 204. This is typically, when temperature sensor 224 detects a temperature around 60° C. on the HDD 202.

Further, in accordance with various embodiments of applicant's teachings, the heating element 204 is independently connected to the source of power so that the first switch 216 cannot disconnect the source of power to the heating element 204. In some embodiments, the heating element 204 is connected to the source of power through the first connector 208.

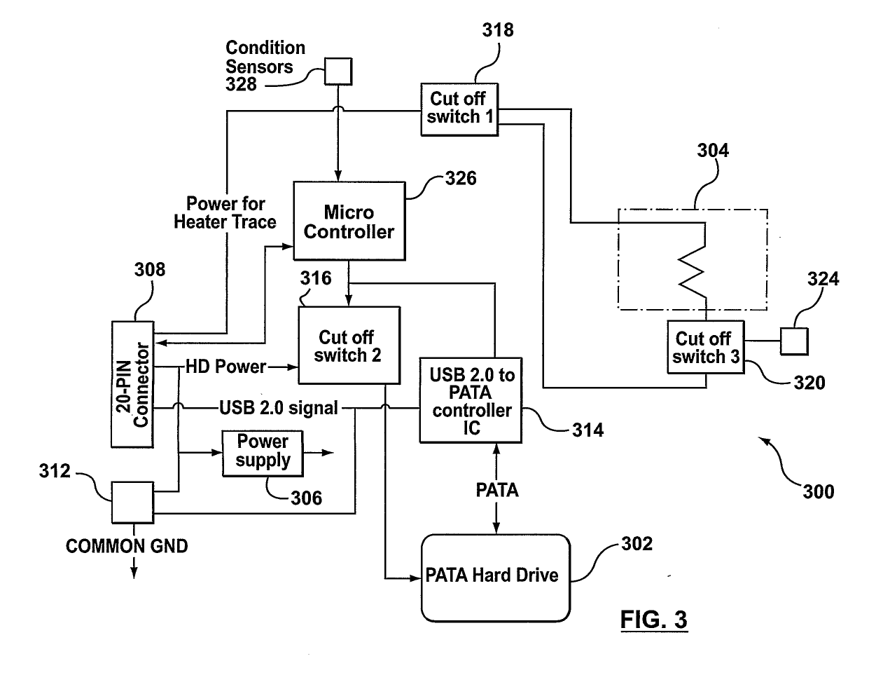

FIG. 3 in a block diagram illustrates a removable data storage device 300 according to various embodiments of applicant's teachings. The data storage device comprises a HDD 302, a heating element 304, a circuit power supply 306, a first connector 308, a second connector 312 with a common ground, a controller 314, a first cutoff switch 316, a second cutoff switch 318, a third cutoff switch 320, and a temperature sensor 324, a micro controller 326, and a condition sensor 328. The embodiments illustrated in FIG. 3 are similar to the embodiments illustrated in FIG. 2 and only the features that differ will be discussed.

Data storage device 300 comprises a microcontroller 326 and one or more condition sensors 328 each of which is linked to microcontroller 326. Each condition sensor 328 can be but is not limited to a temperature sensor, vibration sensor, impact sensor, humidity sensor, or accelerometer as well as, for some embodiments the second temperature sensor (222 as shown in FIG. 2). When a condition sensor 328 senses a condition that is outside the acceptable operating condition of the data storage device, microcontroller 326 causes cutoff switch 318 to disconnect the power supply from HDD 302. The conditions could be any reasonable conditions such as excessive vibrations, shocks, acceleration, humidity or temperature.

Moreover, in some embodiments, microcontroller 326 can control cutoff switch 318 to connect or disconnect power to the heating element 304, similar to as described above in relation to FIG. 2.

For some embodiments of applicant's teachings, cutoff switch 320 operates independently of microcontroller 326. This allows cutoff switch 320 to independently operate as a fail-safe switch to disconnect power to the heating element 304 in the event that either or both of cutoff switch 318 or microcontroller 326 fail to operate.

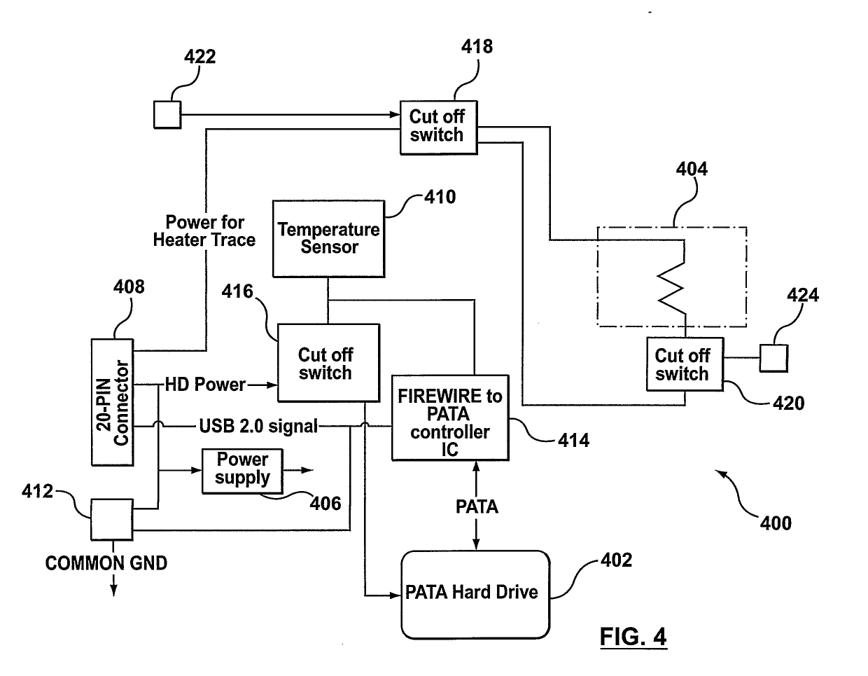

Reference is now made to FIG. 4, which in a block diagram illustrates a removable data storage device 400 according to various embodiments of applicant's teachings. The data storage device comprises a HDD 402, a heating element 404, a circuit power supply 406, a first connector 408, a first sensor 410 (which can be, as previously described, but not limited to, a temperature sensor), a second connector 412 with a common ground, a controller 414, a first cutoff switch 416, a second cutoff switch 418, a third cutoff switch 420, a second temperature sensor 422, and a third temperature sensor 424.

The various embodiments of applicant's teachings as illustrated in FIG. 4 are similar to those illustrated in FIG. 2 except that a different standard is used to connect the data storage device 400 to other devices such as a data receiving apparatus as described above. In the various embodiments illustrated in FIG. 4, the IEEE 1394 high-speed serial bus standard (also known as FIREWIRE™) is used instead of the USB 2.0 standard previously disclosed. Controller 414 is operated to convert between the PATA and FIREWIRE™ standards.

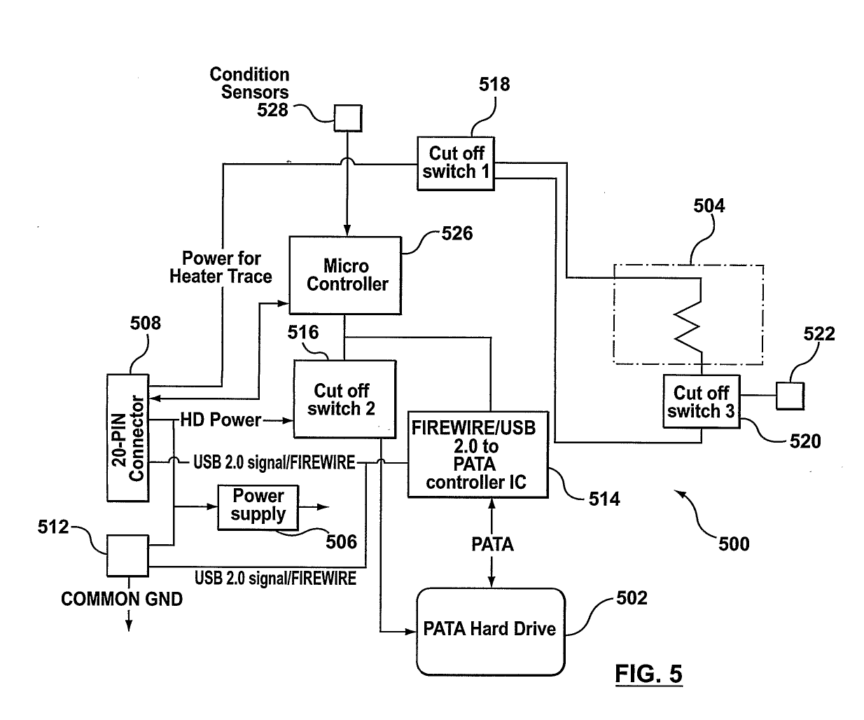

FIG. 5 in a block diagram illustrates a removable data storage device 500 according to various embodiments of applicant's teachings. The data storage device comprises a HDD 502, a heating element 504, a circuit power supply 506, a first connector 508, a second connector 512 with a common ground, a controller 514, a first cutoff switch 516, a second cutoff switch 518, a third cutoff switch 520, and a temperature sensor 524, a micro controller 526, and a condition sensor 528 (which can be, as previously described, but not limited to, a temperature sensor).

The various embodiments of applicant's teachings illustrated in FIG. 5 is similar to that illustrated in FIG. 3 except that a different standard is used to connect to other devices such as a data receiving apparatus as described above. In this embodiment, the FIREWIRE™ standard and the USB 2.0 standard may be used instead of only the USB 2.0 standard. Thus controller 514 is operable to convert between the PATA and FIREWIRE™ standards as well as the PATA and USB 2.0 standards.

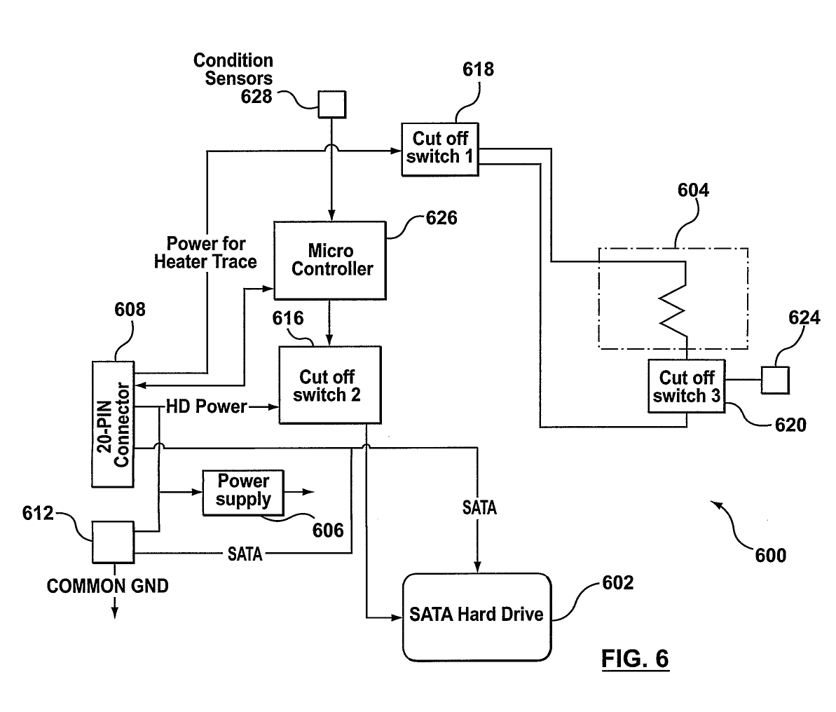

FIG. 6 in a block diagram illustrates a removable data storage device 600 according to various embodiments of applicant's teachings. The data storage device comprises a HDD 602, a heating element 604, a circuit power supply 606, a first connector 608, a second connector 612 with a common ground, a first cutoff switch 616, a second cutoff switch 618, a third cutoff switch 620, and a temperature sensor 324, a micro controller 626, and a condition sensor 628 (which can be, as previously described, but not limited to, a temperature sensor).

The various embodiments of applicant's teachings illustrated in FIG. 6 is similar to that illustrated in FIG. 3 except that HDD 602 is a SATA hard drive and the SATA standard is used to connect to other devices. Given that the same standard is used by the hard drive as that used by the data storage device to connect to other devices a controller such as 314 in FIG. 3 for converting between protocols is not necessary. As will be apparent to those skilled in the art other embodiments may be implemented similar to those illustrated in FIG. 6 except that the hard disk drive operates according to the PATA standard.

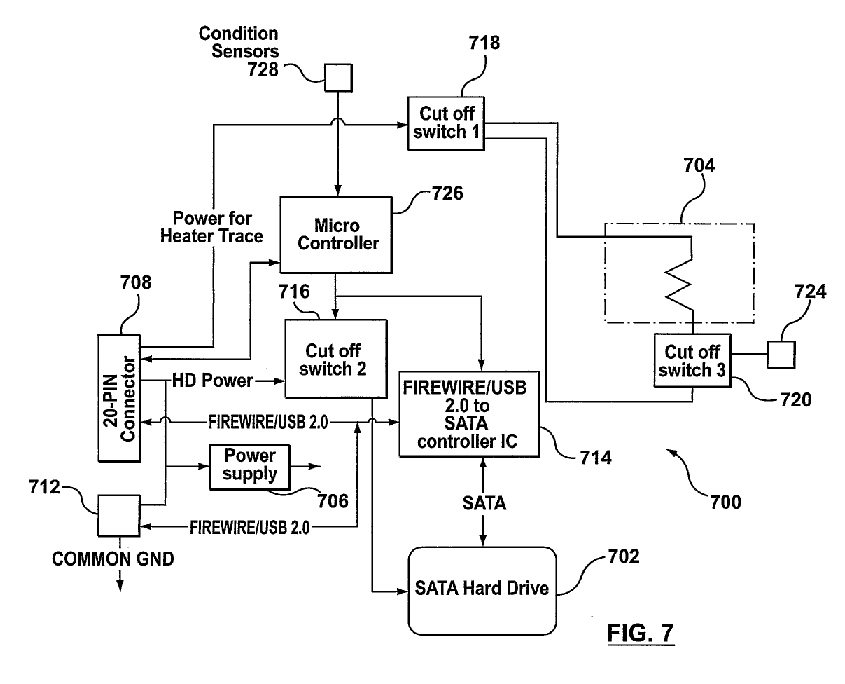

FIG. 7 in a block diagram illustrates a removable data storage device 700 according to various embodiments of applicant's teachings. The data storage device comprises a HDD 702, a heating element 704, a circuit power supply 706, a first connector 708, a second connector 712 with a common ground, a controller 714, a first cutoff switch 716, a second cutoff switch 718, a third cutoff switch 720, and a temperature sensor 724, a micro controller 726, and a condition sensor 728 (which can be, as previously described, but not limited to, a temperature sensor).

The various embodiments of applicant's teachings illustrated in FIG. 7 is similar to FIG. 3 except that the HDD 702 is a SATA hard drive and the FIREWIRE™ and the USB 2.0 standard may used to connect to other devices instead of only the USB 2.0 standard. Thus, controller 714 is operable to convert between the SATA and FIREWIRE™ standards as well as the SATA and USB 2.0 standards.

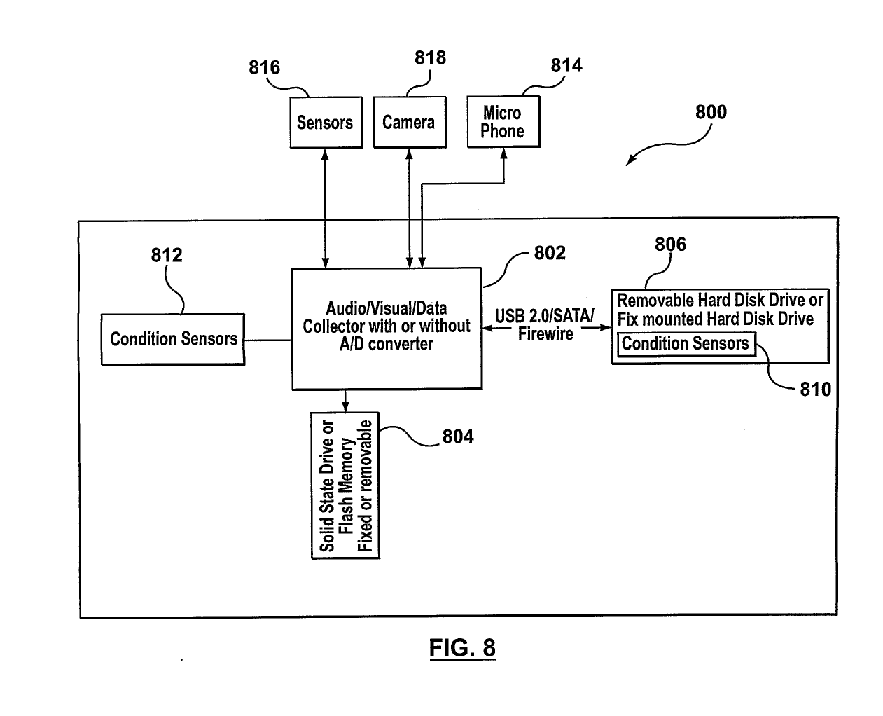

Reference is now made to FIG. 8, which is a block diagram of a data collector 800 according to various embodiments of applicant's teachings. Data collector 800 comprises a data receiving apparatus 802, an initial data storage device 804, a main storage device 806, and condition sensors 810, 812. In addition input devices such as, for example, but not limited to, microphone 814, camera 818, and other type of sensors 820 (for example, but not limited to, temperature, humidity, shock, vibration sensors), provide data to be received by data receiving apparatus 802. The data received could be but is not limited to video, audio, or any other signal whether digital or analog. For example, the data received may be in the form of a data feed from a further data collecting apparatus, or in the form of a GPS signal. Data receiving apparatus 802 may comprise an analog to digital converter (not shown).

In some embodiments of applicant's teachings condition sensors can be located on the data storage device 806 (such as condition sensors 810). In some embodiments of applicant's teachings, condition sensors can be located as part of the data collector 800, such as condition sensors 812 shown in FIG. 8. Moreover, some embodiments of applicant's teachings, the condition sensors can be located in both the data collector 800 (as sensors 812) and the data storage device 806 (as sensors 810). Further, in some embodiments of applicant's teachings the condition sensors might be external to the data collector 800. Conditions sensors 810, 812 operate in a manner similar to that described above.

In various embodiments of applicant's teachings, the at least one initial data storage device 804 has a range of acceptable operating conditions that is greater than the range of acceptable operating conditions of the at least one main data storage device 806. Moreover, in various embodiments of applicant's teachings, the at least one initial data storage device 804 has a power requirement that is less than the power requirement of the main data storage device 806. Accordingly, in various embodiments of applicant's teachings the at least one initial data storage device 804 which has a greater range of operating conditions and/or a lesser power requirement than the main data storage device 806, is operated for a greater total time than the at least one main data storage device 806.

In various embodiments of applicant's teachings the at least one initial data storage device 804 can operate to receive the data from the data receiving apparatus at any time over the data collecting period. In some embodiments of applicant's teachings, the at least one initial data storage device 804 can comprise, for example, a solid-state drive.

In various embodiments of applicant's teachings, the data collector 800 can operate to initially receive and store data in the initial data storage device 804, while the main data storage device 806 is waiting for acceptable operating conditions before powering on. For example, when the temperature is below an acceptable operating temperature for the main data storage device 806, the initial data storage device can operate to receive the data. Once the main data storage device 806 has reached an acceptable operating temperature, the data is transferred from the initial data storage device 804 to the main storage device 806. If desired, thereafter, the initial data storage device 804 can then be powered off and the main data storage device 806 can then continue to receive data from the data receiving apparatus 802. In these embodiments, the main data storage device 806 can be operating longer than the initial data storage device 804, but the data collector can record data almost immediately when powered up, due to the greater acceptable operable range of the initial data storage device 804.

Initial storage device 804 can be but is not limited to a solid-state drive, such as, for example, but not limited to, a flash memory, USB flash memory, USB jump drive, CF flash drive, flash memory with USB 1.1 or USB 2.0 interface, flash memory with CF interface, flash memory with SATA interface, flash memory with PATA interface, flash memory with FIRE interface, any memory device with no moving parts or battery backed SRAM. Initial storage device 804 can be fixed or removable. In other embodiments, initial data storage device 804 can be a hard disk drive that has lower power requirements and a greater range of operating conditions than the memory device used as the main data storage device 806. In some embodiments initial storage device 804 may comprise low power consumption industrial grade rugged 1.8″ hard disk drive or a low power consumption industrial grade rugged 2.5″ hard disk drive.

Main storage device 806 can be, but is not limited to, a removable hard disk drive or a fix mounted disk drive with a PATA or SATA interface. In addition, main storage device 806 can be, but is not limited to, 2.5″ or 3.5″ hard disk drives. In other embodiments, other memory devices than hard disks are used as main storage device 806. In particular it is not intended to exclude solid state memory devices for use as main storage device 806.

As will be explained in further detail below, data collector 800 utilizes an initial storage device 804 to temporarily store data. When it is needed to transfer data to main storage device 806, main storage device 806 is connected to a source of power so that it can operate to receive the data that has been stored on the initial storage device 804. As used herein, the term operate refers to the provision of power to the storage device and does not necessarily imply reading or writing data. This scheme minimizes the use of the main storage device 806 and prolongs its lifetime. In addition, through the use of condition sensors 810 and/or 812, as previously described, the main storage device 806 can be powered on when the operating conditions of the main storage device 806 is within acceptable operating conditions. This too, can prolong the life of the main data storage device 806, by reducing or eliminating it's operation during time of adverse conditions.

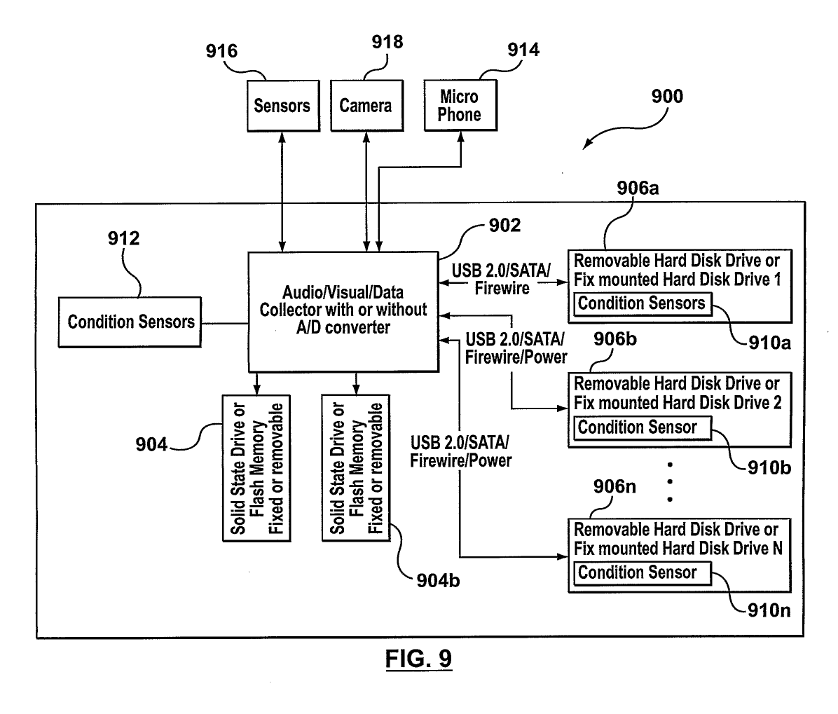

FIG. 9 illustrates various embodiments similar to that of FIG. 8 except that there are a plurality of initial data storage devices and a plurality of main data storage devices. In particular, for the various embodiments as illustrated, in there are 2 initial data storage devices, 904a and 904b, and there are n main storage devices, 910a to 910n. It can be appreciated, however, that the number of initial data storage devices and main data storage devices is not intended to be limited by the embodiments disclosed and illustrated.

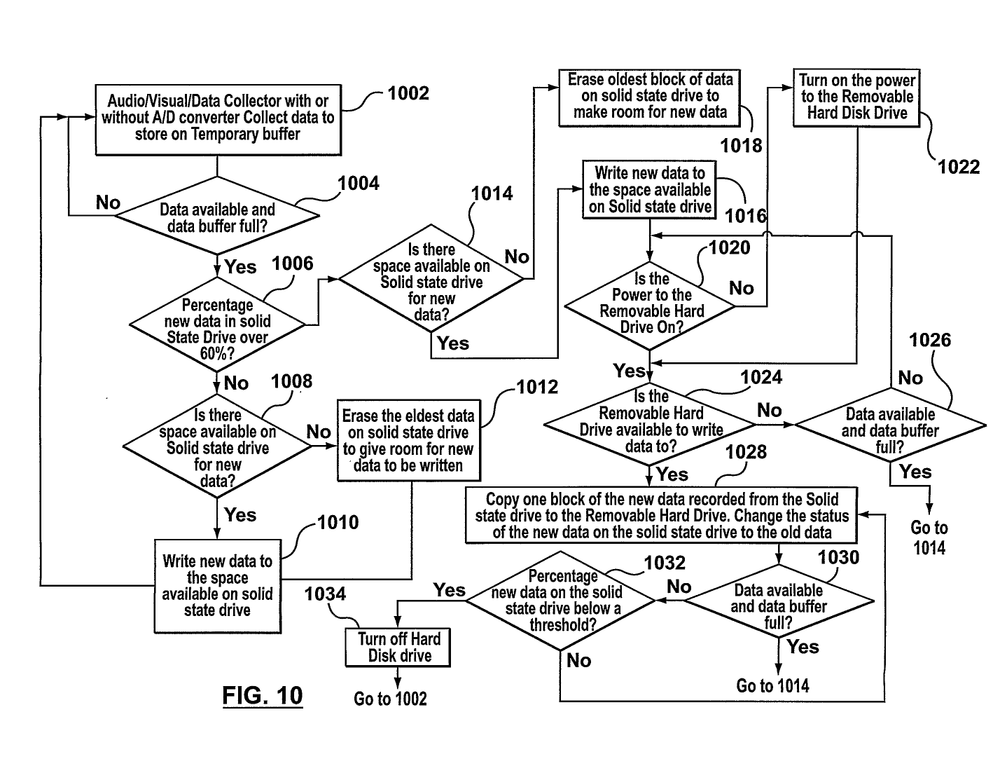

Reference is now made to FIG. 10, which in a flow chart illustrates the steps 1000 taken by various embodiments of applicant's teachings comprising a main data storage device and an initial data storage device but no condition sensors.

At step 1002, data is collected and stored in a temporary buffer, which is part of the data receiving apparatus. As mentioned above the data may be of various types, including but not limited to audio, video, radar and data streams. Moreover the data collected by the data receiving apparatus may be digital or analog. If it is analog then the data receiving apparatus may comprise an analog to digital converter. In such a case, at step 1002, the signal may be converted from an analog to a digital signal.

At step 1004, it is determined whether the data buffer is full and there is data available for storage. If the result is yes, then step 1006 is executed. If on the other hand, the result is no, then step 1002 is repeated.

At step 1006, it is determined whether the amount of new data stored on the initial data storage device exceeds 60% of its total capacity. This threshold is exemplary only and other embodiments may use other thresholds. If the amount of new data does not exceed the threshold then step 1008 is executed. Otherwise, step 1014 is executed.

At step 1008, it is determined whether there is sufficient empty space available on the initial data storage device for storing the new data. If yes, then step 1010 is executed. If not, then step 1012 is executed.

At step 1010, the new data is stored on the space available on the initial data storage device. After step 1010, step 1002 is repeated.

At step 1012, the oldest data is erased from the initial data storage device in order to make room for the new data that is to be written. After step 1012 is executed, step 1010 is performed as described above.

At step 1014, it is determined whether there is sufficient empty space available on the initial data storage device for storing the new data. If not, then step 1016 is executed. If yes, then step 1018 is executed.

At step 1016, the oldest data is erased from the initial data storage device in order to make room for the new data that is to be written. After step 1016 is executed, step 1018 is performed.

At step 1018, the new data is stored on the space available on the initial data storage device. After step 1018 is completed step 1020 is executed.

At step 1020, it is determined whether or not the power is being supplied to the main data storage device. If not, then step 1022 is executed. If yes, the step 1024 is executed.

At step 1022, the power to the main data storage device is turned on. After step 1022 is completed, step 1024 is executed.

At step 1024 it is determined whether or not the main data storage device is available to be written to. If not, then step 1026 is executed. If yes, then step 1028 is executed.

At step 1026 it is determined if there is data available for storage and whether the data buffer is full. If not, then step 1020 is executed. If yes, then step 1014 is executed as explained above.

At step 1028, one block of data is copied from the initial data storage device to the removable hard disk drive. At this same step, the status of the data that has been copied from the initial data storage device is changed from new to old. After step 1028, step 1030 is executed.

At step 1030, it is determined whether there is data available for storage and whether the data buffer is full. If yes, then step 1014 is executed. If not, then step 1032 is executed.

At step 1032 it is determined whether the amount of the new data on the solid state drive as a percentage of the total storage capacity of the solid state drive is below a predetermined threshold. If not, then step 1028 is executed again. If yes then step 1034 is executed. The predetermined threshold may be any appropriate threshold. For example it could be set to 5%. If the threshold is set much lower than the threshold in step 1006, then this check prevents the hard drive from being turned off and then back on again after a very short interval.

At step 1034, the hard drive is turned off. After step 1034 is completed step 1002 is repeated.

As may be noted from the above description, in various embodiments of the applicant's teachings, the main data storage device is operated on only occasionally. Thus, these embodiments of the method of applicant's teachings reduce the time that the main data storage device is required to operate and thereby help extend its lifetime. As used herein, operation of the main data storage device refers to the provision of power to the main data storage device. It does not necessarily imply that the main data storage device is reading or writing data, though it does not exclude that possibility.

As an example of the various embodiments of the method of applicant's teachings consider an embodiment having a 1 Gb Flash drive as an initial data storage device and a 500 Gb removable hard drive as a main data storage device. A typical audio or video data recorder can provide data at a rate of 0.5 Mb/s. However, the rate at which data can be transferred from the solid-state flash drive to the removable hard drive is 15 Mb/s. Thus, it would take 20 minutes to fill 60% (600 Mb) of the solid-state drive, while it would take only 40 seconds to transfer the 600 Mb to the hard drive.

As a second example, consider various embodiments having a 500 Gb hard drive as a main drive and a 2 Gb flash drive as an initial data storage device. If only the hard drive were used to store the data at 0.5 Mb/s it would take 277 hours of continuous operation to fill the entire 500 Gb of storage space. However, when used in conjunction with a 2 Gb flash drive according to the method described above, the hard drive need only be activated for 8 hours out of the 277 hours of data collection time.

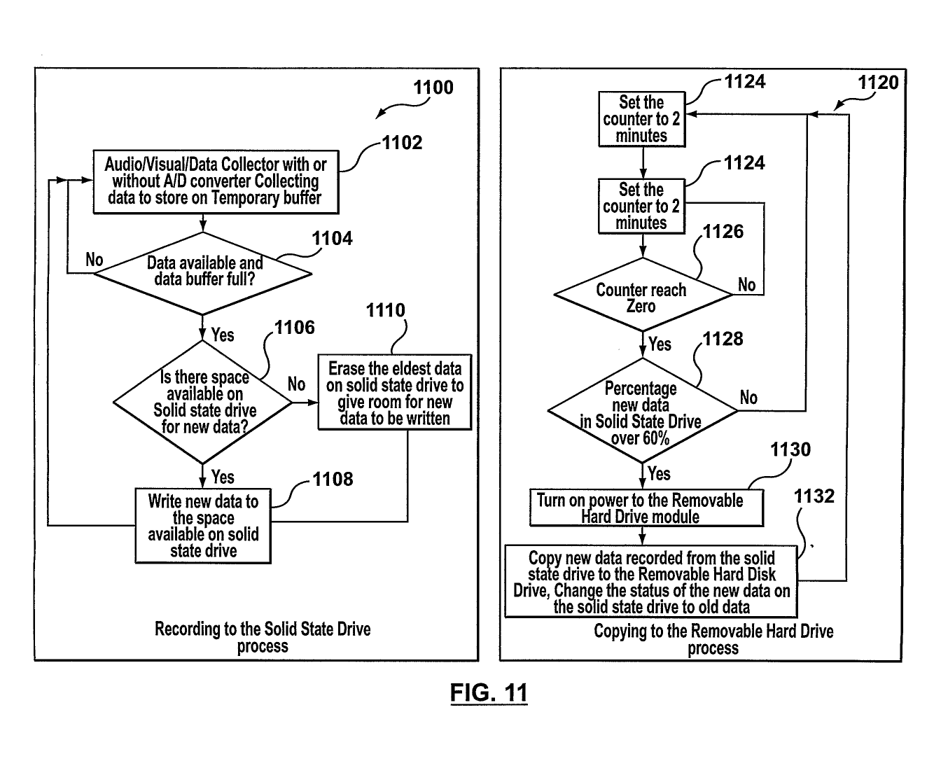

Reference is now made to FIG. 11, which in two flow charts illustrates the steps 1100 and 1120 according to various embodiments of applicant's teachings involved in multi-ask programming. Steps 1100 are the steps taken in recording the collected data to the initial data storage device. Steps 1120 are the steps taken to record data from the initial data storage device to the main data storage device.

Steps 1100 begin with step 1102. At step 1102, data is collected and stored in the temporary buffer.

At step 1104, it is determined whether or not there is data available and whether or not the data buffer is full. If not, then step 1102 is repeated. If yes, then step 1106 is executed.

At step 1106, it is determined whether there is space available on the initial data storage device for new data. If yes, then step 1108 is executed. If not then step 1110 is executed.

At step 1108, the new data is written to the initial data storage device.

At step 1110, the oldest data on the initial data storage device is erased in order to give room for new data to be written. After step 1110, step 1108 is executed and the data is written to the initial data storage device as described above.

Steps 1120 begin with steps 1122. At step 1122, a counter is set to 2 minutes. The amount of time is exemplary only and different embodiments can have different times set. At step 1124, the counter is counted down. At step 1126 it is determined whether the counter has reached zero. If not, then step 1124 is repeated. If yes, then step 1128 is executed.

At step 1128, it is determined whether the amount of new data stored on the initial data storage device exceeds 60% of the total capacity of the drive. This threshold is exemplary only and other embodiments may use other thresholds. If the amount of new data does not exceed the threshold then step 1128 is executed. Otherwise, step 1130 is executed.

At step 1130, power is turned on to the main data storage device module. Once power has been supplied to main data storage device step 1132 is executed. At step 1132, the new data is copied from the initial data storage device to the main data storage device. After step 1132, step 1122 is repeated.

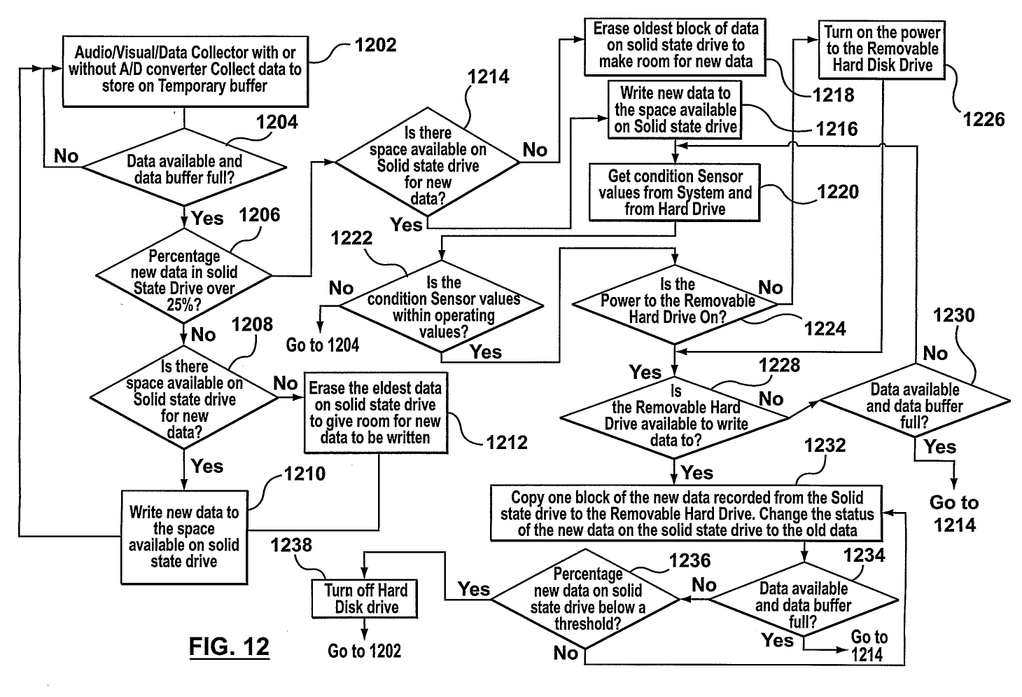

Reference is now made to FIG. 12, which in a flow chart illustrates the steps 1200 according to various embodiments of applicant's teachings taken by various embodiments of a data collector having a main data storage device, an initial data storage device and one or more condition sensors. Thus, steps 1200 may be executed by the various embodiments illustrated in FIG. 8.

At step 1202, data is collected and stored in a temporary buffer. As mentioned above the data may be of various types, including but not limited to audio, video, radar and data streams. Moreover the data collected by the data receiving apparatus may be digital or analog. If it is analog then the data receiving apparatus may comprise an analog to digital converter. In such a case, at step 1202, the signal may be converted from an analog signal to a digital signal.

At step 1204, it is determined whether there data buffer is full and there is data available for storage in the data buffer. If the result is yes, then step 1206 is executed. If on the other hand, the result is no, then step 1202 is repeated.

At step 1206, it is determined whether the amount of new data stored on the initial data storage device exceeds 25% of the total capacity of the drive. This figure is exemplary only and other embodiments may use other thresholds. A lower threshold is used given that this embodiment is to be operated in conditions that may not always be suitable for the main memory to operate. The lower threshold maximizes the probability of a time period with acceptable conditions occurring before the initial data storage device is filled. If the amount of new data does not exceed the threshold, then step 1208 is executed. Otherwise, step 1214 is executed.

At step 1208, it is determined whether there is sufficient empty space available on the initial data storage device for storing the new data. If yes, then step 1210 is executed. If not, then step 1212 is executed.

At step 1210, the new data is stored on the space available on the initial data storage device. After step 1210, step 1202 is repeated.

At step 1212, the oldest data is erased from the initial data storage device in order to make room for the new data that is to be written. After step 1212 is executed, step 1210 is performed as described above.

At step 1214, it is determined whether there is sufficient empty space available on the initial data storage device for storing the new data. If not, then step 1216 is executed. If yes, then step 1218 is executed.

At step 1216, the oldest data is erased from the initial data storage device in order to make room for the new data that is to be written. After step 1216 is executed, step 1218 is performed.

At step 1218, the new data is stored on the space available on the initial data storage device. After step 1218 is completed step 1220 is executed.

At step 1220 the condition sensors are read. As mentioned above, the condition sensors could be vibration sensors or accelerometers, or they could be temperature sensors. After step 1220, step 1222 is executed.

At step 1222, the conditions read from the sensors are compared to the acceptable operating parameters of the main data storage device. If not, then step 1204 is executed as explained above. If yes, then step 1224 is executed.

At step 1224, it is determined whether or not the power is being supplied to the main data storage device. If not, then step 1226 is executed. If yes, the step 1228 is executed.

At step 1226, the power to the removable hard disk drive is turned on. After step 1226 is completed, step 1228 is executed.

At step 1228 it is determined whether or not the main data storage device is available to be written to. If not, then step 1230 is executed. If yes, then step 1232 is executed.

At step 1230 it is determined if there is data available for storage and whether the data buffer is full. If not, then step 1224 is executed. If yes, then step 1214 is executed as explained above.

At step 1232, one block of data is copied from the initial data storage device to the removable hard disk drive. At this same step 12 the status of the data initial data storage device that has been copied is changed from new to old. After step 1232, step 1234 is executed.

At step 1234, it is determined whether there is data available for storage and whether the data buffer is full. If yes, then step 1214 is executed. If not, then step 1236 is executed.

At step 1236 it is determined whether the amount of the new data on the solid state drive as a percentage of the total storage capacity of the solid state drive is below a predetermined threshold. If not, then step 1232 is executed again. If yes then step 1238 is executed. The predetermined threshold may be any appropriate threshold. For example it could be set to 5%. If the threshold is set much lower than the threshold in step 1206, then this check prevents the hard drive from being turned off and then back on again after a very short interval.

At step 1238, the hard drive is turned off. After step 1238 is completed, step 1202 is repeated.

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A removable data storage device comprising:
a. a first connector to removably connect the data storage device to a data receiving apparatus so that data received can be written to the data storage device; and
b. a second connector to removably connect the data storage device to a data processor, the data processor separate from the data receiving apparatus.

2. The removable data storage device according to claim 1, wherein the first connector is a multiple point contact connector.

3. The removable data storage device according to claim 1, wherein the first connector is a multiple-pin connector.

4. The removable data storage device according to claim 1, wherein the second connector is a universal serial bus connector.

5. The removable data storage device according to claim 1, wherein the second connector is a serial advanced technology attachment connector.

6. The removable data storage device according to claim 1, wherein the second connector is an IEEE 1394 high-speed serial bus connector.

7. The removable data storage device according to claim 1, further comprising a memory device connected to the first connector and the second connector.

8. The removable data storage device according to claim 7, further comprising a printed circuit board upon which the memory device, first connector and second connector are mounted.

9. The removable data storage device according to claim 8, wherein the memory device communicates with the first and second connector via the printed circuit board.

10. The removable data storage device according to claim 7, wherein the memory device is a hard disk drive.

11. A method of providing a data storage device to be interfaced between a data receiving apparatus in a data collecting configuration and a data processor in a data retrieval configuration, the method comprising:
a. in a data collecting configuration, connecting the data storage device to a data receiving apparatus by a first connector so that data received can be written to the data storage device; and
b. in a data retrieval configuration, disconnecting the data storage device from the data receiving apparatus, and connecting the data storage device to a data processor by a second data connector so that data from the data storage device can be received by the data processor.

12. The method according to claim 11, wherein the first connector is a multiple point contact connector.

13. The method according to claim 12, wherein the first connector is a multiple-pin connector.

14. The method according to claim 11, wherein the second connector is a universal serial bus connector.

15. The method according to claim 11, wherein the second connector is a serial advanced technology attachment connector.

16. The method according to claim 11, wherein the second connector is an IEEE 1394 high-speed serial bus connector.

17. The method according to claim 11, wherein the data storage device comprises a memory device connected to the first connector and the second connector.

18. The method according to claim 17, wherein the data storage device comprises a printed circuit board upon which the memory device, first connector and second connector are mounted.

19. The method according to claim 18, wherein the memory device communicates with the first connector and the second connector via the printed circuit board.

20. The method according to claim 17, wherein the memory device is a hard disk drive.

21. A data storage device comprising:
a. a first connector to connect the data storage device to a data receiving apparatus;
b. at least one sensor to sense at least one condition relevant to an acceptable operating condition of the data storage device; and
c. a first switch linked to the at least one sensor, the first switch to disconnect a source of power to the data storage device when the sensor senses a condition outside the acceptable operating condition of the data storage device.

22-50. (canceled)

51. A method of selectively operating a data storage device to receive data from a data receiving apparatus, the method comprising:
a. connecting the data storage device to a data receiving apparatus;
b. sensing at least one condition relevant to an acceptable operating condition of the data storage device; and
c. upon sensing a condition outside the acceptable operating condition of the data storage device, disconnecting a source of power to the data storage device.

52-84. (canceled)

85. A data collector, comprising:
d. a data receiving apparatus;
e. at least one initial data storage device to receive data from the data receiving apparatus, the at least one initial data storage device operable for a first total time over a data collecting period; and
f. at least one main data storage device to receive the data from the at least one initial data storage device, the at least one main data storage device operable for a second total time over the data collecting period, the second total time less than the first total time.

86-106. (canceled)

107. A method of reducing the time that a main data storage device in a data collector is in operation while it is collecting data, comprising:
a. transferring data from a data receiving apparatus to at least one initial data storage device, the at least one initial data storage device operable for a first total time over a data collecting period; and
b. transferring the data from the at least one initial data storage device to at least one main data storage device, the at least one main data storage device operable for a second total time over the data collecting period, the second total time less than the first total time.

108-126. (canceled)

127. A data collector comprising:
a. a data receiving apparatus;
b. at least one initial data storage device to receive data from the data receiving apparatus, the at least one initial data storage device having a first range of acceptable operating conditions; and
c. at least one main data storage device to receive the data storage device, the at least one main data storage device having a second range of acceptable operating conditions, the second range of acceptable operating conditions less than the first range of operating conditions.

128. A method of collecting data while a main data storage device is not in operation due to adverse operating conditions, comprising:
a. transferring data from a data receiving apparatus to at least one initial data storage device while at least one main data storage device is not in operation due to adverse operating conditions; and
b. transferring the data from the at least one initial data storage device to at least one main data storage device once the at least one main data storage device is within acceptable operating conditions.

129. (canceled)
